(19) United States
(12) Patent Application Publication
(10) Pub. No.: US 2025/0142644 A1
(43) Pub. Date: May 1, 2025

(54) TECHNIQUES FOR BACKHAUL RELEASE OF AN ACCESS NODE

(71) Applicant: QUALCOMM Incorporated, San Diego, CA (US)

(72) Inventors: Naeem AKL, Bridgewater, NJ (US); Karl Georg HAMPEL, Jersey City, NJ (US)

(21) Appl. No.: 18/781,606

(22) Filed: Jul. 23, 2024

Related U.S. Application Data
(60) Provisional application No. 63/595,318, filed on Nov. 1, 2023.

(51) Int. Cl. H04W 76/10; H04W 76/20; H04W 76/36

(52) U.S. Cl. CPC H04W 76/10; H04W 76/20; H04W 76/36

(57) ABSTRACT

Methods, systems, and devices for wireless communications are described. An access node may establish a signaling connection (e.g., an F1 connection) with a first central unit (CU) and establish a radio resource control (RRC) connection with a second CU, where the signaling connection may be used for backhauling of communications for user equipments (UEs) served by the access node. The first CU may transmit to the access node a first indication associated with suspension of the backhauling of the communications via the signaling connection. Additionally, the first CU may transmit to the second CU a second indication that indicates the suspension of the backhauling of the communications via the signaling connection. As such, the second CU may transmit to the access node, a third indication that indicates for the access node to release backhaul resources for support of the communications associated with the UEs based on receiving the second indication.

### CROSS REFERENCE

The present Application for Patent claims the benefit of U.S. Provisional Patent Application No. 63/595,318 by AKL et al., entitled “TECHNIQUES FOR BACKHAUL RELEASE OF AN ACCESS NODE,” filed Nov. 1, 2023, assigned to the assignee hereof, and expressly incorporated by reference herein.

### FIELD OF TECHNOLOGY

The following relates to wireless communications, including techniques for backhaul release of an access node.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for backhaul release of an access node. For example, the described techniques provide for an explicit indication of an F1 connection status. In some cases, a first central unit (CU) may communicate wirelessly with a distributed unit (DU) of an integrated access and backhaul (IAB) node (e.g., an IAB-DU) in accordance with an F1 connection. The first CU may communicate with the IAB-DU directly, or via one or more additional DUs (e.g., donor DUs of an IAB network). The first CU may be an example of a CU terminating the F1 connection that carries backhaul traffic for the IAB-DU, and may establish a radio resource control (RRC) connection with a mobile termination (MT) of the IAB node (e.g., an IAB-MT) for radio resource management and authentication for the IAB-DU. In some cases, the RRC connection for the IAB-MT may be handed off to a second CU, which may then communicate (e.g., wirelessly) with the MT of the IAB node for radio resource management and authentication. The F1 connection may be maintained to the first CU, such that the traffic for the F1 connection may be offloaded to the connection topology between the second CU and the IAB node.

In some examples, the first CU may transmit an indication that indicates the suspension of the backhauling of the communications via the F1 connection. In some cases, the indication of the suspension of the backhauling may be included in an IAB transport migration modification request message. In some examples, the indication may indicate to the second CU an F1 connection release. In some examples, the indication may indicate to the second CU that the F1 connection has not yet been released. In some examples, the indication may indicate to the second CU that the backhauling via the IAB node is suspended but the F1 connection may be maintained. In some examples, the indication may indicate to the second CU that the first CU has transmitted a request for F1 connection release to the IAB node (e.g., an F1 connection release procedure has been initiated, but is not finished). In some examples, the indication may indicate to the second CU that the IAB node is no longer serving any UEs (e.g., no UEs may be affected by the release of backhaul resources). Additionally, or alternatively, the IAB node may transmit the indication of the F1 connection status.

A method for wireless communications by a first CU is described. The method may include establishing a signaling connection with an access node, where the access node has a RRC connection with a second CU, and where the signaling connection is used for backhauling of communications for UEs that are served by the access node, transmitting, to the access node, a first indication associated with suspension of the backhauling of the communications via the signaling connection, and transmitting, to the second CU, a second indication that indicates the suspension of the backhauling of the communications via the signaling connection.

A first CU for wireless communications is described. The first CU may include one or more memories storing processor executable code, and one or more processors coupled with the one or more memories. The one or more processors may individually or collectively operable to execute the code to cause the first CU to establish a signaling connection with an access node, where the access node has an RRC connection with a second CU, and where the signaling connection is used for backhauling of communications for UEs that are served by the access node, transmit, to the access node, a first indication associated with suspension of the backhauling of the communications via the signaling connection, and transmit, to the second CU, a second indication that indicates the suspension of the backhauling of the communications via the signaling connection.

Another first CU for wireless communications is described. The first CU may include means for establishing a signaling connection with an access node, where the access node has an RRC connection with a second CU, and where the signaling connection is used for backhauling of communications for UEs that are served by the access node, means for transmitting, to the access node, a first indication associated with suspension of the backhauling of the communications via the signaling connection, and means for transmitting, to the second CU, a second indication that indicates the suspension of the backhauling of the communications via the signaling connection.

A non-transitory computer-readable medium storing code for wireless communications is described. The code may include instructions executable by a processor to establish a signaling connection with an access node, where the access node has an RRC connection with a second CU, and where the signaling connection is used for backhauling of communications for UEs that are served by the access node, transmit, to the access node, a first indication associated with suspension of the backhauling of the communications via the signaling connection, and transmit, to the second CU, a second indication that indicates the suspension of the backhauling of the communications via the signaling connection.

In some examples of the method, first CUs, and non-transitory computer-readable medium described herein, the second indication that indicates the suspension of the backhauling of the communications indicates release of an F1 connection between the first CU and a DU of the access node.

In some examples of the method, first CUs, and non-transitory computer-readable medium described herein, the second indication that indicates the suspension of the backhauling of the communications indicates that an F1 connection between the first CU and a DU of the access node may be maintained during the suspension of the backhauling.

In some examples of the method, first CUs, and non-transitory computer-readable medium described herein, transmitting the second indication may include operations, features, means, or instructions for transmitting, to the second CU, an integrated access and backhaul transport migration modification request message that includes the second indication.

In some examples of the method, first CUs, and non-transitory computer-readable medium described herein, the second indication that indicates the suspension of the backhauling of the communications indicates that backhauling via the access node may be suspended.

In some examples of the method, first CUs, and non-transitory computer-readable medium described herein, the first indication indicates a request to release an F1 connection between the first CU and a DU of the access node and the second indication indicates that the first CU may have requested to release the F1 connection.

In some examples of the method, first CUs, and non-transitory computer-readable medium described herein, the second indication that indicates the suspension of the backhauling of the communications indicates that the access node may be serving zero UEs.

Some examples of the method, first CUs, and non-transitory computer-readable medium described herein may further include operations, features, means, or instructions for receiving, from the second CU, a deauthorization status for backhaul operation of the access node, where transmission to the access node of the first indication associated with the suspension of the backhauling of the communications may be in accordance with receiving the deauthorization status.

In some examples of the method, first CUs, and non-transitory computer-readable medium described herein, the second indication further indicates for the second CU to release all data traffic associated with the first CU.

A method for wireless communications by a second CU is described. The method may include establishing an RRC connection with an access node, where the access node has a signaling connection with a first CU for backhauling of communications with UEs served by the access node, receiving a first indication that indicates a suspension of the backhauling of the communications via the signaling connection, and transmitting, to the access node, a second indication that indicates for the access node to release backhaul resources for support of the communications associated with the user equipment (UE)s based on receiving the first indication.

A second CU for wireless communications is described. The second CU may include one or more memories storing processor executable code, and one or more processors coupled with the one or more memories. The one or more processors may individually or collectively operable to execute the code to cause the second CU to establish an RRC connection with an access node, where the access node has a signaling connection with a first CU for backhauling of communications with UEs served by the access node, receive a first indication that indicates a suspension of the backhauling of the communications via the signaling connection, and transmit, to the access node, a second indication that indicates for the access node to release backhaul resources for support of the communications associated with the UEs based on receiving the first indication.

Another second CU for wireless communications is described. The second CU may include means for establishing an RRC connection with an access node, where the access node has a signaling connection with a first CU for backhauling of communications with UEs served by the access node, means for receiving a first indication that indicates a suspension of the backhauling of the communications via the signaling connection, and means for transmitting, to the access node, a second indication that indicates for the access node to release backhaul resources for support of the communications associated with the UEs based on receiving the first indication.

A non-transitory computer-readable medium storing code for wireless communications is described. The code may include instructions executable by a processor to establish an RRC connection with an access node, where the access node has a signaling connection with a first CU for backhauling of communications with UEs served by the access node, receive a first indication that indicates a suspension of the backhauling of the communications via the signaling connection, and transmit, to the access node, a second indication that indicates for the access node to release backhaul resources for support of the communications associated with the UEs based on receiving the first indication.

In some examples of the method, second CUs, and non-transitory computer-readable medium described herein, the first indication that indicates the suspension of the backhauling of the communications indicates release of an F1 connection between the first CU and a DU of the access node.

In some examples of the method, second CUs, and non-transitory computer-readable medium described herein, the first indication that indicates the suspension of the backhauling of the communications indicates that an F1 connection between the first CU and a DU of the access node may be maintained during the suspension of the backhauling.

In some examples of the method, second CUs, and non-transitory computer-readable medium described herein, receiving the first indication may include operations, features, means, or instructions for receiving, from the first CU, an integrated access and backhaul transport migration modification request message that includes the first indication.

In some examples of the method, second CUs, and non-transitory computer-readable medium described herein, the first indication that indicates the suspension of the backhauling of the communications indicates that backhauling via the access node may be suspended.

In some examples of the method, second CUs, and non-transitory computer-readable medium described herein, the first indication indicates that the first CU may have requested to release an F1 connection between the first CU and a DU of the access node.

In some examples of the method, second CUs, and non-transitory computer-readable medium described herein, the first indication that indicates the suspension of the backhauling of the communications indicates that the access node may be serving zero UEs.

Some examples of the method, second CUs, and non-transitory computer-readable medium described herein may further include operations, features, means, or instructions for receiving, from an authorization and mobility management function (AMF), a deauthorization status for backhaul operation of the access node and transmitting, to the first CU, the deauthorization status for the backhaul operation of the access node, where reception of the first indication that indicates the suspension of the backhauling of the communications may be accordance with the deauthorization status.

In some examples of the method, second CUs, and non-transitory computer-readable medium described herein, the first indication further indicates for the second CU to release all data traffic associated with the first CU.

In some examples of the method, second CUs, and non-transitory computer-readable medium described herein, the second CU receives the first indication from the access node or from the first CU.

In some examples of the method, second CUs, and non-transitory computer-readable medium described herein, the backhaul resources include a backhaul adaptation protocol (BAP) address, a transport network layer (TNL) address, a BAP reconfiguration, or a combination thereof.

### BRIEF DESCRIPTION OF THE DRAWINGS

FIG. 1 shows an example of a wireless communications system that supports techniques for backhaul release of an access node in accordance with one or more aspects of the present disclosure.

FIG. 2 shows an example of a network architecture that supports techniques for backhaul release of an access node in accordance with one or more aspects of the present disclosure.

FIG. 3 shows an example of a wireless communications system that supports techniques for backhaul release of an access node in accordance with one or more aspects of the present disclosure.

FIG. 4 shows an example of a process flow that supports techniques for backhaul release of an access node in accordance with one or more aspects of the present disclosure.

FIGS. 5 and 6 show block diagrams of devices that support techniques for backhaul release of an access node in accordance with one or more aspects of the present disclosure.

FIG. 7 shows a block diagram of a communications manager that supports techniques for backhaul release of an access node in accordance with one or more aspects of the present disclosure.

FIG. 8 shows a diagram of a system including a device that supports techniques for backhaul release of an access node in accordance with one or more aspects of the present disclosure.

FIGS. 9 through 12 show flowcharts illustrating methods that support techniques for backhaul release of an access node in accordance with one or more aspects of the present disclosure.

### DETAILED DESCRIPTION

Some wireless communications systems may employ central units (CUs) and mobile integrated access and backhaul (IAB) nodes to provide communication service to one or more user equipments (UEs). A mobile IAB node may include a distributed unit (DU) and a mobile termination (MT). For example, a mobile IAB node may include a DU (e.g., IAB-DU) to communicate wirelessly with one or more UEs and an MT to communicate wirelessly with one or more CUs or DUs (e.g., donor DUs) of a network. A first CU may be an example of a CU terminating an F1 connection that carries backhaul traffic for the IAB-DU, and may establish a radio resource control (RRC) connection with a MT of the IAB node (e.g., IAB-MT) for radio resource management and authentication for the IAB-DU.

In some cases, the RRC connection for the IAB-MT may be handed off to a second CU, which may then communicate (e.g., wirelessly) with the MT of the IAB node for radio resource management and authentication. The F1 connection may be maintained to the first CU, such that the traffic for the F1 connection may be offloaded to the connection topology between the second CU and the IAB node. In such an example, the first CU may be an example of an F1-terminating CU and the second CU may be an example of an RRC-terminating CU.

In some approaches, the second CU (e.g., connected to the IAB-MT) may receive an indication of the authorization status of a mobile IAB node from an authorization and mobility management function (AMF). The AMF may change the authorization status of the mobile IAB node. In this case, the second CU may receive the updated authorization status from the AMF. In some cases, the updated status from the AMF may indicate a mobile-IAB non-authorized indication. The IAB node may no longer be authorized to support IAB operations. As such, the first CU (e.g., connected to the IAB-DU) may release F1 connection with the IAB node, and indicate to the second CU to release any previously offloaded traffic. However, without explicit indication of an F1 connection status, the second CU may release the backhaul resources at a time that inefficiently utilizes communication services. For instance, if the second CU releases the backhaul resources too early, the first CU may lose F1 connection prior to proper release of the F1 connection. Additionally, or alternatively any UEs still connected to the IAB node may experience radio link failure (RLF). If, however, the second CU releases the backhaul resources too late, the IAB node may attempt to set up another F1 connection with another CU, even if the IAB node is not authorized to do so.

Some examples of the techniques described herein may provide approaches for the first CU transmitting to the second CU an indication of the F1 connection status. For example, the first CU may transmit an indication that indicates the suspension of the backhauling of the communications. In some cases, the indication of the F1 connection status may be included in an IAB transport migration modification request message. In some examples, the indication may indicate to the second CU an F1 connection release. In some examples, the indication may indicate to the second CU that the F1 connection has not yet been released. In some examples, the indication may indicate to the second CU that the backhauling via the IAB node is suspended but the F1 connection may be maintained. In some examples, the indication may indicate to the second CU that the first CU has transmitted a request for F1 connection release to the IAB node (e.g., an F1 connection release procedure has been initiated, but is not finished). In some examples, the indication may indicate to the second CU that the IAB node is no longer serving any UEs (e.g., no UEs may be affected by the release of backhaul resources). Additionally, or alternatively, the IAB node may transmit the indication of the F1 connection status.

As such, the second CU may use indication that indicates the suspension of the backhauling to determine a time at which to release backhaul resources associated with the IAB node. By timing the release of the backhaul resources in accordance with the suspension of the backhauling, the wireless network may realize an increase in utilization of communication resources, or reduce occurrences of RLFs experienced by one or more UEs serviced by an IAB node, or both.

Aspects of the disclosure are initially described in the context of wireless communications systems, network architecture, and a process flow. Aspects of the disclosure are further illustrated by and described with reference to apparatus diagrams, system diagrams, and flowcharts that relate to techniques for backhaul release of an access node.

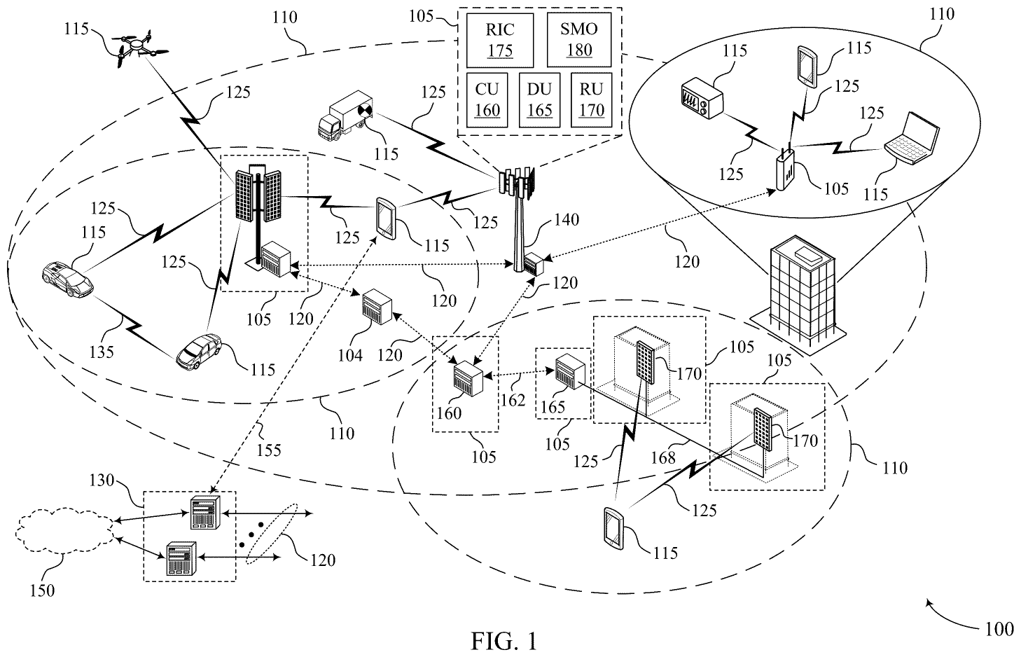

FIG. 1 shows an example of a wireless communications system 100 that supports techniques for backhaul release of an access node in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a CU 160, a DU 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). An IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. An IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. In some cases, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for backhaul release of an access node as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and

unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples of wireless communications system 100, a first CU 160 may be an example of a CU 160 terminating an F1 connection that carries backhaul traffic for a DU 165 of an IAB node (e.g., IAB-DU), and may establish an RRC connection with a MT of the IAB node (e.g., IAB-MT) for radio resource management and authentication for the IAB-DU.

In some cases, the RRC connection for the IAB-MT may be handed off to a second CU 160, which may then communicate (e.g., wirelessly) with the MT of the IAB node for radio resource management and authentication. The F1 connection may be maintained to the first CU 160, such that the traffic for the F1 connection may be offloaded to the connection topology between the second CU 160 and the IAB node. In such an example, the first CU 160 may be an example of an F1-terminating CU 160 and the second CU 160 may be an example of an RRC-terminating CU 160.

Some examples of the techniques described herein may provide approaches for the first CU 160 transmitting to the second CU 160 an indication of the F1 connection status. For example, the first CU 160 may transmit an indication that indicates the suspension of the backhauling of the communications. In some cases, the indication of the F1 connection status may be included in an IAB transport migration modification request message. In some examples, the indication may indicate to the second CU 160 an F1 connection release. In some examples, the indication may indicate to the second CU 160 that the F1 connection has not yet been released. In some examples, the indication may indicate to the second CU 160 that the backhauling via the IAB node 104 is suspended but the F1 connection may be maintained. In some examples, the indication may indicate to the second CU 160 that the first CU 160 has transmitted a request for F1 connection release to the IAB node 104 (e.g., an F1 connection release procedure has been initiated, but is not finished). In some examples, the indication may indicate to the second CU 160 that the IAB node 104 is no longer serving any UEs 115 (e.g., no UEs 115 may be affected by the release of backhaul resources). Additionally, or alternatively, the IAB node 104 may transmit the indication of the F1 connection status.

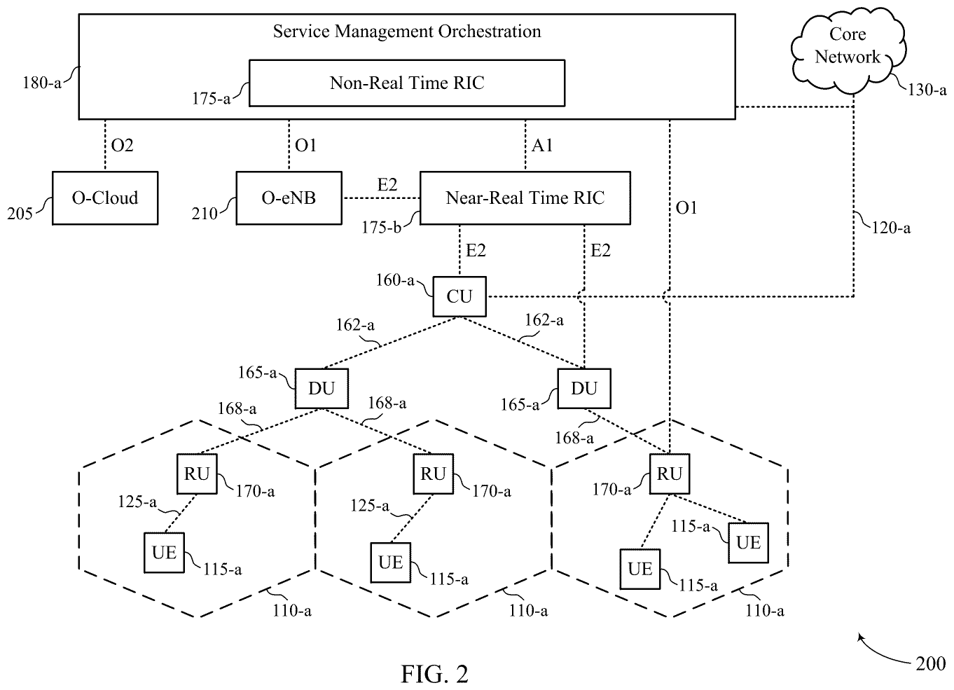

FIG. 2 shows an example of a network architecture 200 (e.g., a disaggregated base station architecture, a disaggregated RAN architecture) that supports techniques for backhaul release of an access node in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an Al interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In some examples of network architecture 200, a first CU 160-a may be an example of a CU 160-a terminating an F1 connection that carries backhaul traffic for a DU 165-a of an IAB node (e.g., IAB-DU), and may establish an RRC connection with a MT of the IAB node (e.g., IAB-MT) for radio resource management and authentication for the IAB-DU.

In some cases, the RRC connection for the IAB-MT may be handed off to a second CU 160-a, which may then communicate (e.g., wirelessly) with the MT of the IAB node for radio resource management and authentication. The F1 connection may be maintained to the first CU 160-a, such that the traffic for the F1 connection may be offloaded to the connection topology between the second CU 160-a and the IAB node. In such an example, the first CU 160-a may be an example of an F1-terminating CU 160-a and the second CU 160-a may be an example of an RRC-terminating CU 160-a.

Some examples of the techniques described herein may provide approaches for the first CU 160-a transmitting to the second CU 160-a an indication of the F1 connection status. For example, the first CU 160-a may transmit an indication that indicates the suspension of the backhauling of the communications. In some cases, the indication of the F1 connection status may be included in an IAB transport migration modification request message. In some examples, the indication may indicate to the second CU 160-a an F1 connection release. In some examples, the indication may indicate to the second CU 160-a that the F1 connection has not yet been released. In some examples, the indication may indicate to the second CU 160-a that the backhauling via the IAB node is suspended but the F1 connection may be maintained. In some examples, the indication may indicate to the second CU 160-a that the first CU 160-a has transmitted a request for F1 connection release to the IAB node (e.g., an F1 connection release procedure has been initiated, but is not finished). In some examples, the indication may indicate to the second CU 160-a that the IAB node is no longer serving any UEs 115 (e.g., no UEs 115 may be affected by the release of backhaul resources). Additionally, or alternatively, the IAB node may transmit the indication of the F1 connection status.

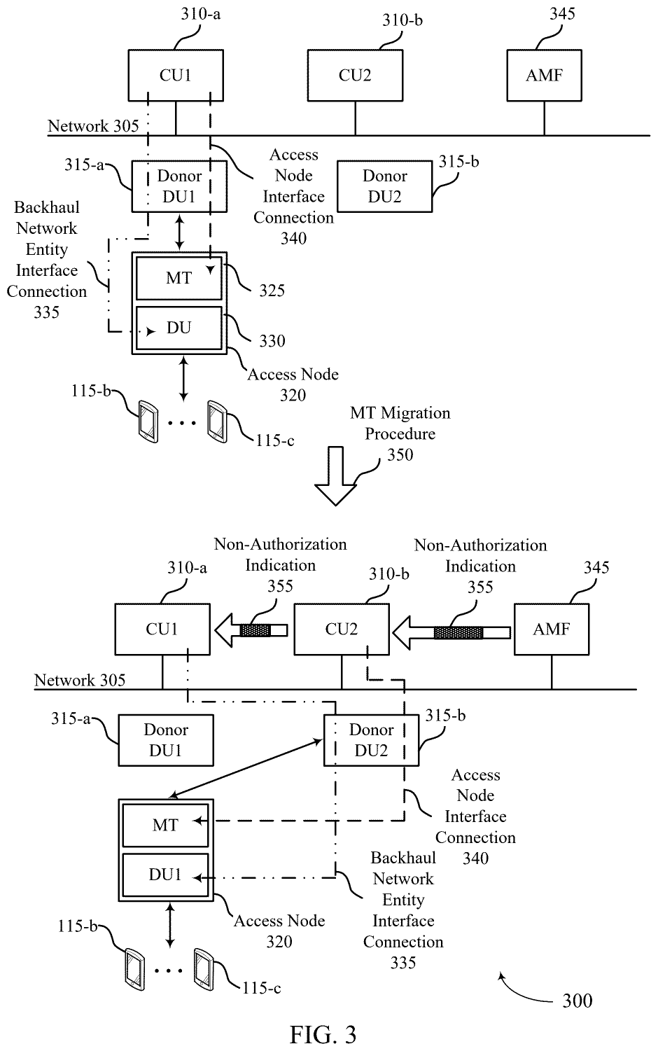

FIG. 3 shows an example of a wireless communications system 300 that supports techniques for backhaul release of an access node in accordance with one or more aspects of the present disclosure. In some examples, the wireless communications system 300 may implement or be implemented by aspects of the wireless communications system 100, the network architecture 200, or any combination thereof. For example, the wireless communications system 300 may include one or more network entities 105 and one or more UEs 115 (e.g., UE 115-b through UE 115-c), which may be examples of the corresponding devices described herein with reference to FIG. 1. In the example of FIG. 2, the one or more network entities 105 may be examples of a CU 160 (e.g., a CU 310), a DU 165 (e.g., a donor DU 315), an RU 170, a base station 140, an IAB node 104 (e.g., an access node 320), or one or more other network nodes as described herein with reference to FIG. 1.

The wireless communications system 300 may include a first CU 310-a (e.g., CU1), a second CU 310-b (e.g., CU2), and an AMF 345 connected via a network 305. Additionally, one or more donor DUs 315 (e.g., donor-DU1 and donor-DU2) may be connected to the network 305, such that one or more of the CUs 310 may communicate with an access node 320 (e.g., IAB node) via the donor DUs 315. For instance, a first donor DU 315-a may be associated with communications for the first CU 310-a and a second donor DU 315-b may be associated with communications for the second CU 310-b. For example, a given donor DU 315 may be part of a topology of a respective CU 310 the given donor DU 315 is associated with. Additionally, the access node 320 may include an MT 325 (e.g., IAB-MT), and a DU 330 (e.g., IAB-DU).

As illustrated in FIG. 3, the wireless communications system 300 may support integration of the access node 320 at a single CU 310. For instance, both the MT 325 and the DU 330 may be associated with the first CU 310-a. The first CU 310-a may serve as a donor node for the MT 325 and the DU 330. In some cases, the first CU 310-a may communicate with MT 325 via an access node interface connection 340 (e.g., an RRC connection). In some cases, the first CU 310-a may communicate with the DU 330 via a backhaul network entity interface connection 335 (e.g., an F1 connection). The backhaul network entity interface connection 335 may allow for the access node 320 to serve as an interface between one or more UEs 115 and the network 305, to allow for the communication of one or more data packets between the one or more UEs 115 and the network 305. Based on the first CU 310-a being connected to the DU 330 via the backhaul network entity interface connection 335, the first CU 310-a may be an example of an F1-terminating node donor (e.g., a IAB-DU's CU). Additionally, while FIG. 3 illustrates the access node 320 serving the UE 115-b and 115-c, it is understood that the access node may serve any quantity of UEs 115 or any quantity of other wireless device types.

In some examples, the MT 325 and the DU 330 may be associated with different CUs 310. For example, as illustrated in FIG. 3, the access node 320 may perform an MT migration procedure 350, where the termination point of the MT 325 may be switched between different CUs 310. For example, the access node interface connection 340 may be switched from the first CU 310-a to the second CU 310-b. In such examples, the backhaul network entity interface connection 335 may be routed via the topology of the second CU 310-b (e.g., via the second donor DU 315-b). Based on the second CU 310-b being connected to the MT 325 via the access node interface connection 340, the second CU 310-b may be an example of a non-F1-terminating node donor (e.g., an IAB-MT's CU).

In some cases, the MT migration procedure 350 may be initiated by the F1-terminating node donor (e.g., the first CU 310-a). In such cases, the MT migration procedure 350 may provide a means to exchange information between the F1-terminating node donor and the non-F1-terminating node donor to manage the migration of access node traffic between the topologies managed by the first CU 310-a and the second CU 310-b. In some examples, the MT migration procedure 350 may use UE associated signaling. For instance, the first CU 310-a may initiate the MT migration procedure 350 by sending a migration management request message (e.g., an IAB transport management request). The first CU 310-a may use the request message to indicate traffic that the first CU 310-a wants to offload to the second CU 310-b, where the traffic is associated with the one or more UEs 115 serviced by the access node 320. As such, the request message may indicate an identifier associated with access node 320, a traffic index indicating which traffic the first CU 310-a is requesting to offload, one or more quality of service (QoS) parameters associated with the traffic, or a combination thereof. In some examples, the second CU 310-b may use the information included in the request message to configure the second donor DU 315-b (e.g., donor DU2) to serve as a router between the first CU 310-a and the access node 320 (e.g., communicate data packets between the UEs 115 and the first CU 310-a to allow for both uplink and downlink communications). As part of the configuration of the second donor DU 315-b, the second CU 310-b may indicate which IP address and IP header fields correspond to the first CU 310-a, such that the second donor DU 315-b may use the indicated IP addresses and header fields to identify which data packets belong with communications for the first CU 310-a. Based on configuring the second donor DU 315-b, the second CU 310-b may transmit a response message to the first CU 310-a (e.g., an IAB transport management response). In some examples, the response message may indicate that the second donor DU 315-b is configured to route communications for the backhaul network entity interface connection 335, and may indicate which IP header fields and IP addresses for the first CU 310-a to use when routing IP packets via the second donor DU 315-b (e.g., via the topology of the second CU 310-b).

Additionally or alternately, the first CU 310-a may modify the traffic offloaded to the second CU 310-b. For example, one or more UEs 115 may leave the service of the access node 320 or one or more UEs 115 may start service via the access node 320. As such, the first CU 310-a may transmit a request message that modifies the traffic offloaded to the second CU 310-b. The second CU 310-b may use the request message to modify the second donor DU 315-b to route data in accordance with the updated traffic offload. Additionally, the second CU 310-b may transmit a response to the first CU 310-a indicating that modification to the traffic offloaded to the second donor DU 315-b/

Additionally, or alternatively, the second CU 310-b may modify the traffic offloaded by the first CU 310-a. For example, the second CU 310-b may modify the transport (e.g., switch from the second donor DU 315-b to a different donor DU 315 to serve as the router). Additionally, or alternatively, the second CU 310-b may be overloaded with traffic (e.g., be associated with a quantity of data above a configured threshold). As such, the second CU 310-b may transmit a request to the first CU 310-a indicating a modification to the traffic routed through the topology of the second CU 310-b.

In some examples, the access node 320 may have an associated authorization status to extend the network 305. For example, the AMF 345 (e.g., management function network node) may determine (e.g., query) whether the access node 320 is authorized to access one or more network entities (e.g., the first CU 310-a, the second CU 310-b, or both). For instance, the access node 320 may be an example of a mobile access node 320, which may move between different network regions. As such, the access node 320 may be authorized to perform IAB operations in a first location (e.g., associated with a first network region) and may not be authorized to perform IAB operations in a second location (e.g., associated with a second network region). Additionally, or alternatively, the access node 320 may be associated with a subscription service which may allow the access node 320 to perform IAB operations. As such, if the subscription information for the access node 320 changes, the access node 320 may no longer be authorized to perform IAB operations.

If the AMF 345 determines that the access node 320 is not authorized to perform IAB operations, the AMF 345 may transmit to the RRC terminating CU 310 (e.g., the second CU 310-b) a non-authorization indication 355 (e.g., during a mobile IAB-node integration procedure). If the second CU 310-b receives the non-authorization indication 355, the second CU 310-b may refrain from establishing backhaul resources for the access node 320. Such backhaul resources may include one or more of a backhaul adaptation protocol (BAP) address, a transport network layer (TNL) address, and a default BAP configuration.

In the example of wireless communications system 300, where the MT 325 and the DU 330 are connected to respective CUs 310, the RRC terminating CU 310 (e.g., the second CU 310-b) may inform the F1-terminating CU 310 (e.g., the first CU 310-a) about the authorization status of the access node 320. For instance, the second CU 310-b may transmit to the first CU 310-a, via XnAP signaling, the non-authorization indication 355 of the access node 320. If the access node 320 is not authorized for IAB operations, the F1-termianting CU 310 (e.g., the first CU 310-a) may perform a handover operation for the one or more UEs 115 served by the access node 320, and may release the F1 interface towards the DU 330 (e.g., terminate backhaul network entity interface connection 335). Based on terminating the F1 interface, the first CU 310-a may request the second CU 310-b, to release all of the offloaded traffic. Based on releasing the offloaded traffic, the second CU 310-b may release all of the backhaul resources associated with the access node 320.

In some cases, however, it may be advantageous for the first CU 310-a to transmit to the second CU 310-b an explicit indication regarding a status of the F1 release. For example, if the first CU 310-a configures the backhaul network entity interface connection 335 through the topology of the second CU 310-b, but does not offload traffic to the second CU 310-b, the first CU 310-a may not transmit an indication for the second CU 310-b to release offloaded traffic. In such an example, the second CU 310-b may not be aware that the first CU 310-a has released the F1 connection with the access node 320. Without explicit indication of the status of the F1 connection release, the time at which the second CU 310-b determines to release the backhaul resources may reduce the service quality of the network 305. For instance, if the second CU 310-b releases the backhaul resources prior to completion of the F1 connection release, the F1 connection may be lost without proper F1 release. In cases where one or more UEs 115 are still serviced by the access node 320 (e.g., UEs 115 that have not yet completed handover), the one or more UEs 115 may lose service, experience radio link failure, or both. If, however, the second CU 310-b releases the backhaul resources at a relatively long duration after F1 connection release, the access node 320 may attempt another F1 connection set up with a different CU 310 (e.g., even if the access node 320 is not authorized to perform IAB operations).

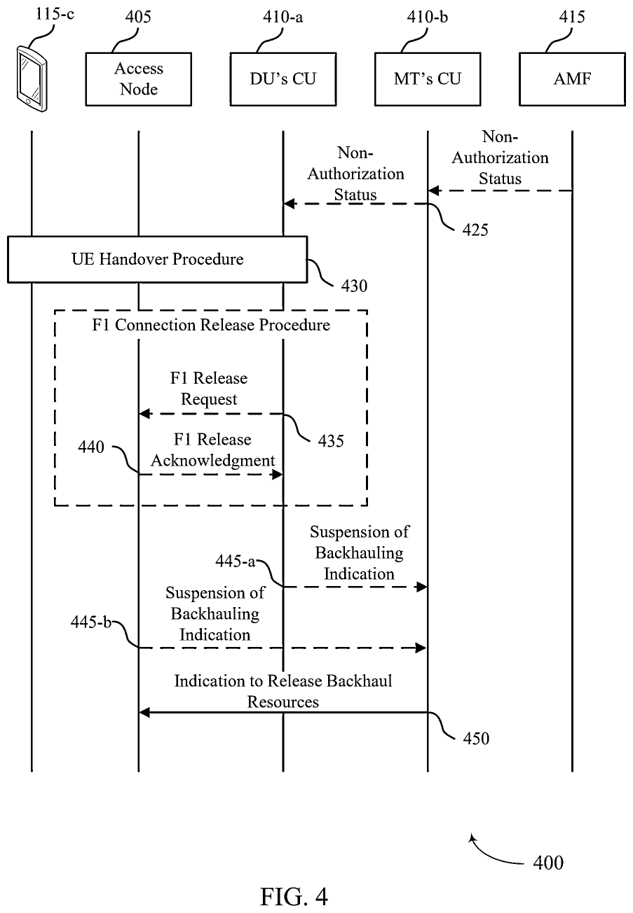

As such, the wireless communications system 300 may implement the techniques described herein to coordinate the timing between the release of the F1 connection and the release of the backhaul resources. For example, the first CU 310-a may transmit to the second CU 310-b an indication that indicates the suspension of the backhauling of communications via the access node interface connection 340. In some cases, the indication may be included in an IAB transport migration modification request message. In some examples, the indication may indicate to the second CU 310-b that the F1 connection release is complete. In some examples, the indication may indicate to the second CU 310-b that the F1 connection has not yet been released. In some examples, the indication may indicate to the second CU 310-b that the backhauling via the access node is suspended but the F1 connection may be maintained. In some examples, the indication may indicate to the second CU 310-b that the first CU 310-a has transmitted a request for F1 connection release to the access node 320 (e.g., an F1 connection release procedure has been initiated, but is not finished). In some examples, the indication may indicate to the second CU 310-b that the access node 320 is no longer serving any UEs 115 (e.g., no UEs 115 may be affected by the release of backhaul resources). Additionally, or alternatively, the access node 320 may transmit the indication of the suspension of the backhauling of communications via the access node interface connection 340. Further discussion of indications regarding the status of the F1 connection are described herein, including with reference to FIG. 4.

FIG. 4 shows an example of a process flow 400 that supports techniques for backhaul release of an access node in accordance with one or more aspects of the present disclosure. In some examples, process flow 400 may implement aspects of wireless communications system 100 network architecture 200, and wireless communications system 300. Process flow 400 includes a UE 115-c, an access node 405, one or more CUs 410, and an AMF 415, which may be respective examples of a UE 115, an access node 320, CUs 310, and an AMF 345 as described with reference to FIGS. 1 through 3. Alternative examples of the following may be implemented, where some steps are performed in a different order than described or are not performed at all. In some cases, steps may include additional features not mentioned below, or further steps may be added. In addition, it should be understood that these processes may occur between any quantity of network devices and network device types.

The process flow 400 may include a first CU 410-a, which may be an example of a DU's CU (e.g., a CU that serves as a terminating point for the backhaul network entity interface connection 335, as described with reference to FIG. 3). For example, the access node 405 and the first CU 410-a may establish a signaling connection (e.g., the F1 connection), where signaling connection is used for backhauling of communications for the UEs 115 that are served by the access node 405. Additionally, the process flow 400 may include a second CU 410-b, which may be an example of an MT's CU (e.g., a CU that serves as a terminating point for the access node interface connection 340, as described with reference to FIG. 3). For example, the access node 405 and the second CU 410-b may establish an RRC connection.

In some examples, at 420 the AMF 415 may transmit to the second CU 410-b, a non-authorization status associated with the access node 405. For example, the second CU 410-b may receive a deauthorization status for backhaul operation of the access node 405. For instance, the access node 405 may be an example of mobile access node 405, and may transition from an authorized status for performing IAB operations to a non-authorized status based on a location of the access node 405. Additionally, or alternatively, the access node 405 may be associated with a subscription to perform IAB operations, and may transition from an authorized status for performing IAB operations to a non-authorized status based on the subscription.

If the second CU 410-b received the non-authorization status (e.g., at 420), then at 425 the second CU 410-b may relay the non-authorization status to the first CU 410-a. For example, the second CU 410-b may transmit to the first CU 410-a, the deauthorization status for backhaul operations of the access node 405.

In some cases, the first CU 410-a may determine to suspend communications associated with the signaling connection of the DU of the access node 405. For instance, the first CU 410-a may determine to release the F1 connection associated with access node 405. In some examples, the first CU 410-a may determine to release the F1 connection based on receiving the non-authorization status associated with the access node 405. Additionally, or alternatively, the first CU 410-a may determine to release the F1 connection to perform a maintenance procedure, to reduce energy expenditure (e.g., at the first CU 410-a, at the access node 405, or both), or a combination thereof.

Based on determining to release the F1 connection, at 430 the first CU 410-a, the access node 405, and one or more UEs 115 serviced by the access node 405 may perform a handover procedure. For example, the access node 405, the first CU 410-a, or both may indicate to the UE 115-c to handover service to a different network entity. As such, the UE 115-c may perform measurement and evaluation of one or more network cells and determine a target cell to transition service to. While FIG. 4 illustrates a single UE 115-c serviced by the access node 405, it is understood that the access node 405 may service any quantity of UEs 115, where each UE 115 may perform a respective handover procedure.

In some examples, the first CU 410-a and the access node 405 may perform an F1 connection release procedure. For example, at 435 the first CU 410-a may transmit to the access node 405, an F1 release request. In some examples, the F1 release request may be an example of an indication associated with suspension of the backhauling of the communications via the signaling connection. As such, at 440 the access node 405 may transmit an F1 release acknowledgment in response to the first CU 410-a. In some examples, the F1 release acknowledgment may indicate successful release of the F1 connection.

At 445, the second CU 410-b may receive an indication that indicates the suspension of the backhauling of the communications via the signaling connection (e.g., the backhaul network entity interface connection 335). As illustrated in FIG. 4, the second CU 410-b may receive the indication of the suspension from the first CU 410-a (e.g., at 445-a), from the access node 405 (e.g., at 445-b), or both.

In some examples, the indication that indicates the suspension of the backhauling of the communications indicates release of the F1 connection between the first CU 410-a and the DU the access node 405.

In some examples, the indication that indicates the suspension of the backhauling of the communications indicates that the F1 connection between the first CU 410-a and the DU of the access node 405 is maintained during the suspension of the backhauling. For example, if the first CU 410-a and the access node 405 are performing the F1 connection procedure, or if one or more UEs 115 are still service by the access node 405, the indication may indicate that the F1 connection has not yet been released. Such an indication may allow the second CU 410-b to refrain from releasing backhaul resources associated with the access node 405 prior to the release of the FI connection.

In some examples, the first CU 410-a may transmit the indication that indicates the suspension of the backhauling of the communications as part of an IAB transport migration modification request message (e.g., as described with reference to FIG. 3).

In some examples, the first CU 410-a may suspend backhauling via the signaling connection, but may maintain the F1 connection with the DU of the access node 405. In such examples, the indication that indicates the suspension of the backhauling of the communications indicates that backhauling via the access node 405 is suspended (e.g., F1 is not released).

In some examples, the second CU 410-b may receive the indication that indicates the suspension of the backhauling of the communications during the F1 connection release procedure. For instance, the second CU 410-b may receive the indication after the first CU 410-a transmits the F1 release request (e.g., at 435) and prior to the access node 405 transmitting the F1 release acknowledgment (e.g., at 440). As such, the indication indicates that the first CU 410-a has requested to release the F1 connection. Such an indication may allow the second CU 410-b to determine that the F1 connection is in the process of being released, such that the second CU 410-b can time the release of backhaul resources as to not interfere with the F1 connection release.

In some examples, the indication that indicates the suspension of the backhauling of the communications indicates that the access node 405 is serving zero UEs (e.g., all UEs 115 have successfully transitioned away from being served by the access node 405). Such an indication may allow the second CU 410-b to determine that releasing the backhaul resources associated with access node 405 may not interfere with the handover of UEs serviced by the access node 405.

In some examples, the indication that indicates the suspension of the backhauling of the communications may further indicate additional information. For example, the indication may additionally indicate for the second CU 410-b to release all data traffic associated with the first CU 410-a (e.g., in cases where the first CU 410-a offloaded data traffic to the second CU 410-b). As such, the indication to release all data traffic may be different than the indication of the suspension of the backhauling of the communications. For instance, the indication to release all data traffic indicates that the second CU 410-b may deconfigured an associated donor DU (e.g., the second donor DU 315-b, as described in FIG. 3) from relaying traffic associated with the first CU 410-a and the access node 405. Alternatively, the indication of the suspension of the backhauling of the communications indicates that backhauling is suspended for the signaling connection between the access node 405 and the first CU 410-a.

At 450, the second CU 410-b may transmit to the access node 405 an indication that indicates for the access node 405 to release backhaul resources for support of the communications associated with the UEs 115 based on receiving the indication of the suspension of the backhauling. In some examples, the backhaul resources may include a BAP address, a TNL address, BAP reconfiguration, or a combination thereof.

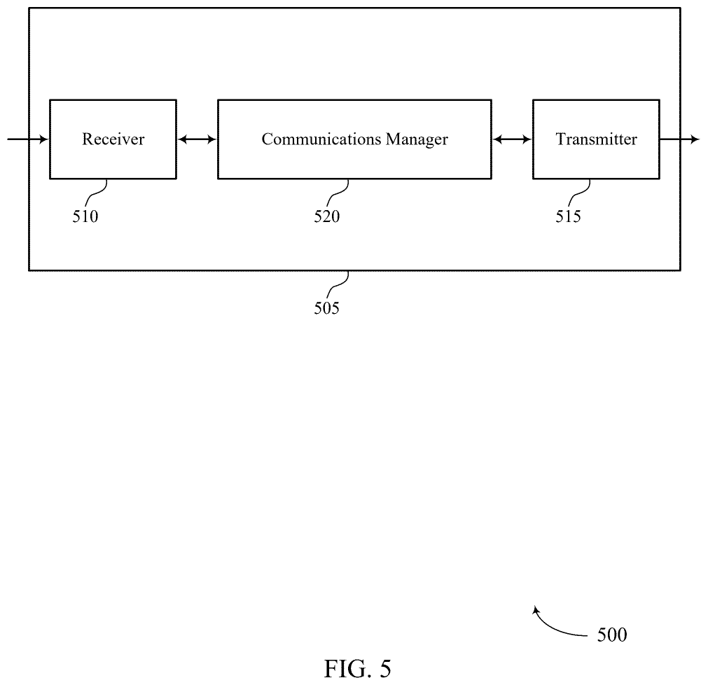

FIG. 5 shows a block diagram 500 of a device 505 that supports techniques for backhaul release of an access node in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations thereof or various components thereof may be examples of means for performing various aspects of techniques for backhaul release of an access node as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for establishing a signaling connection with an access node, where the access node has an RRC connection with a second CU, and where the signaling connection is used for backhauling of communications for UEs that are served by the access node. The communications manager 520 is capable of, configured to, or operable to support a means for transmitting, to the access node, a first indication associated with suspension of the backhauling of the communications via the signaling connection. The communications manager 520 is capable of, configured to, or operable to support a means for transmitting, to the second CU, a second indication that indicates the suspension of the backhauling of the communications via the signaling connection.

Additionally, or alternatively, the communications manager 520 may support wireless communications in accordance with examples as disclosed herein. For example, the communications manager 520 is capable of, configured to, or operable to support a means for establishing an RRC connection with an access node, where the access node has a signaling connection with a first CU for backhauling of communications with UEs served by the access node. The communications manager 520 is capable of, configured to, or operable to support a means for receiving a first indication that indicates a suspension of the backhauling of the communications via the signaling connection. The communications manager 520 is capable of, configured to, or operable to support a means for transmitting, to the access node, a second indication that indicates for the access node to release backhaul resources for support of the communications associated with the UEs based on receiving the first indication.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources.

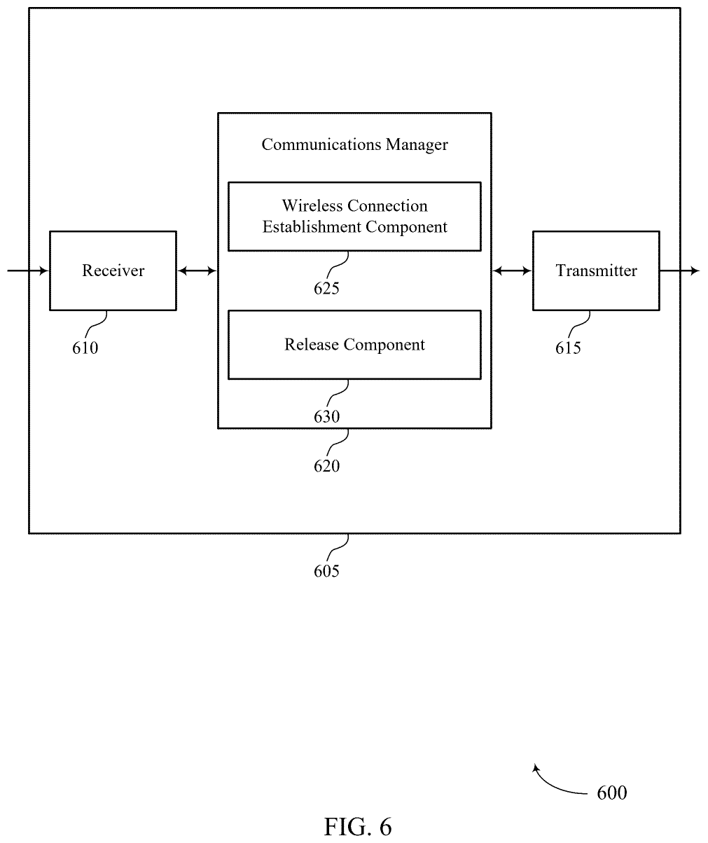

FIG. 6 shows a block diagram 600 of a device 605 that supports techniques for backhaul release of an access node in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of techniques for backhaul release of an access node as described herein. For example, the communications manager 620 may include a wireless connection establishment component 625 a release component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The wireless connection establishment component 625 is capable of, configured to, or operable to support a means for establishing a signaling connection with an access node, where the access node has an RRC connection with a second CU, and where the signaling connection is used for backhauling of communications for UEs that are served by the access node. The release component 630 is capable of, configured to, or operable to support a means for transmitting, to the access node, a first indication associated with suspension of the backhauling of the communications via the signaling connection. The release component 630 is capable of, configured to, or operable to support a means for transmitting, to the second CU, a second indication that indicates the suspension of the backhauling of the communications via the signaling connection.

Additionally, or alternatively, the communications manager 620 may support wireless communications in accordance with examples as disclosed herein. The wireless connection establishment component 625 is capable of, configured to, or operable to support a means for establishing an RRC connection with an access node, where the access node has a signaling connection with a first CU for backhauling of communications with UEs served by the access node. The release component 630 is capable of, configured to, or operable to support a means for receiving a first indication that indicates a suspension of the backhauling of the communications via the signaling connection. The release component 630 is capable of, configured to, or operable to support a means for transmitting, to the access node, a second indication that indicates for the access node to release backhaul resources for support of the communications associated with the UEs based on receiving the first indication.

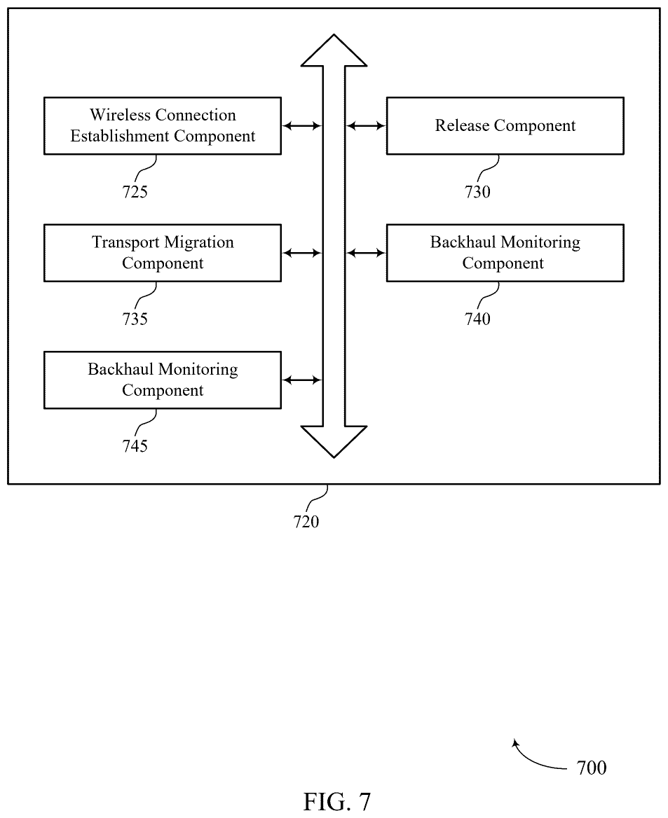

FIG. 7 shows a block diagram 700 of a communications manager 720 that supports techniques for backhaul release of an access node in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for backhaul release of an access node as described herein. For example, the communications manager 720 may include a wireless connection establishment component 725, a release component 730, a transport migration component 735, a backhaul monitoring component 740, a backhaul monitoring component 745, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The wireless connection establishment component 725 is capable of, configured to, or operable to support a means for establishing a signaling connection with an access node, where the access node has an RRC connection with a second CU, and where the signaling connection is used for backhauling of communications for UEs that are served by the access node. The release component 730 is capable of, configured to, or operable to support a means for transmitting, to the access node, a first indication associated with suspension of the backhauling of the communications via the signaling connection. In some examples, the release component 730 is capable of, configured to, or operable to support a means for transmitting, to the second CU, a second indication that indicates the suspension of the backhauling of the communications via the signaling connection.

In some examples, the second indication that indicates the suspension of the backhauling of the communications indicates release of an F1 connection between the first CU and a DU of the access node.

In some examples, the second indication that indicates the suspension of the backhauling of the communications indicates that an F1 connection between the first CU and a DU of the access node is maintained during the suspension of the backhauling.

In some examples, to support transmitting the second indication, the transport migration component 735 is capable of, configured to, or operable to support a means for transmitting, to the second CU, an integrated access and backhaul transport migration modification request message that includes the second indication.

In some examples, the second indication that indicates the suspension of the backhauling of the communications indicates that backhauling via the access node is suspended.

In some examples, the first indication indicates a request to release an F1 connection between the first CU and a DU of the access node. In some examples, the second indication indicates that the first CU has requested to release the F1 connection.

In some examples, the second indication that indicates the suspension of the backhauling of the communications indicates that the access node is serving zero UEs.

In some examples, the backhaul monitoring component 740 is capable of, configured to, or operable to support a means for receiving, from the second CU, a deauthorization status for backhaul operation of the access node, where transmission to the access node of the first indication associated with the suspension of the backhauling of the communications is in accordance with receiving the deauthorization status.

In some examples, the second indication further indicates for the second CU to release all data traffic associated with the first CU.

Additionally, or alternatively, the communications manager 720 may support wireless communications in accordance with examples as disclosed herein. In some examples, the wireless connection establishment component 725 is capable of, configured to, or operable to support a means for establishing an RRC connection with an access node, where the access node has a signaling connection with a first CU for backhauling of communications with UEs served by the access node. In some examples, the release component 730 is capable of, configured to, or operable to support a means for receiving a first indication that indicates a suspension of the backhauling of the communications via the signaling connection. In some examples, the release component 730 is capable of, configured to, or operable to support a means for transmitting, to the access node, a second indication that indicates for the access node to release backhaul resources for support of the communications associated with the UEs based on receiving the first indication.

In some examples, the first indication that indicates the suspension of the backhauling of the communications indicates release of an F1 connection between the first CU and a DU of the access node.

In some examples, the first indication that indicates the suspension of the backhauling of the communications indicates that an F1 connection between the first CU and a DU of the access node is maintained during the suspension of the backhauling.

In some examples, to support receiving the first indication, the backhaul monitoring component 745 is capable of, configured to, or operable to support a means for receiving, from the first CU, an integrated access and backhaul transport migration modification request message that includes the first indication.

In some examples, the first indication that indicates the suspension of the backhauling of the communications indicates that backhauling via the access node is suspended.

In some examples, the first indication indicates that the first CU has requested to release an F1 connection between the first CU and a DU of the access node.

In some examples, the first indication that indicates the suspension of the backhauling of the communications indicates that the access node is serving zero UEs.

In some examples, the backhaul monitoring component 745 is capable of, configured to, or operable to support a means for receiving, from an AMF, a deauthorization status for backhaul operation of the access node. In some examples, the release component 730 is capable of, configured to, or operable to support a means for transmitting, to the first CU, the deauthorization status for the backhaul operation of the access node, where reception of the first indication that indicates the suspension of the backhauling of the communications is accordance with the deauthorization status.

In some examples, the first indication further indicates for the second CU to release all data traffic associated with the first CU.

In some examples, the second CU receives the first indication from the access node or from the first CU.

In some examples, the backhaul resources include a BAP address, a TNL address, a BAP reconfiguration, or a combination thereof.

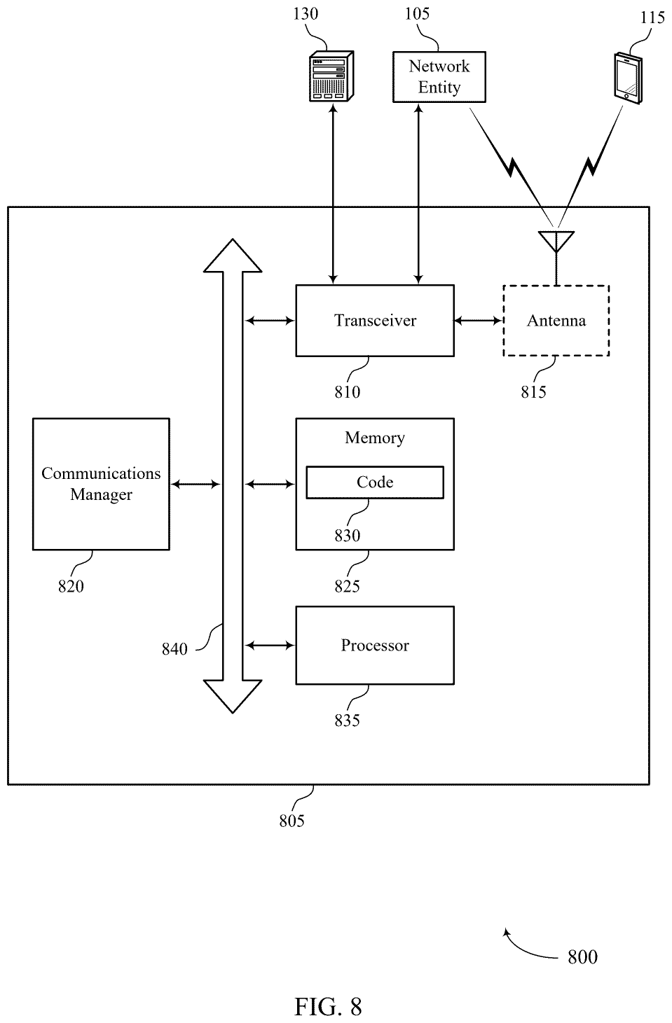

FIG. 8 shows a diagram of a system 800 including a device 805 that supports techniques for backhaul release of an access node in accordance with one or more aspects of the present disclosure. The device 805 may be an example of or include the components of a device 505, a device 605, or a network entity 105 as described herein. The device 805 may communicate with one or more network entities 105, one or more UEs 115, or any combination thereof, which may include communications over one or more wired interfaces, over one or more wireless interfaces, or any combination thereof. The device 805 may include components that support outputting and obtaining communications, such as a communications manager 820, a transceiver 810, an antenna 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., a communication link 125, a backhaul communication link 120, a midhaul communication link 162, a fronthaul communication link 168).

The at least one memory 825 may include RAM, ROM, or any combination thereof. The at least one memory 825 may store computer-readable, computer-executable code 830 including instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may contain, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting techniques for backhaul release of an access node). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825). In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. As such, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with other network entities 105, and may include a controller or scheduler for controlling communications with UEs 115 in cooperation with other network entities 105. In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for establishing a signaling connection with an access node, where the access node has an RRC connection with a second CU, and where the signaling connection is used for backhauling of communications for UEs that are served by the access node. The communications manager 820 is capable of, configured to, or operable to support a means for transmitting, to the access node, a first indication associated with suspension of the backhauling of the communications via the signaling connection. The communications manager 820 is capable of, configured to, or operable to support a means for transmitting, to the second CU, a second indication that indicates the suspension of the backhauling of the communications via the signaling connection.

Additionally, or alternatively, the communications manager 820 may support wireless communications in accordance with examples as disclosed herein. For example, the communications manager 820 is capable of, configured to, or operable to support a means for establishing an RRC connection with an access node, where the access node has a signaling connection with a first CU for backhauling of communications with UEs served by the access node. The communications manager 820 is capable of, configured to, or operable to support a means for receiving a first indication that indicates a suspension of the backhauling of the communications via the signaling connection. The communications manager 820 is capable of, configured to, or operable to support a means for transmitting, to the access node, a second indication that indicates for the access node to release backhaul resources for support of the communications associated with the UEs based on receiving the first indication.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of techniques for backhaul release of an access node as described herein, or the at least one processor 835 and the at least one memory 825 may be otherwise configured to, individually or collectively, perform or support such operations.

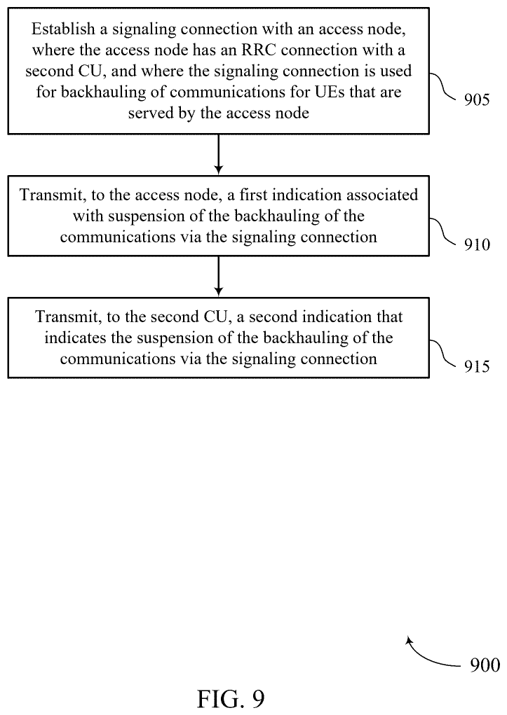

FIG. 9 shows a flowchart illustrating a method 900 that supports techniques for backhaul release of an access node in accordance with aspects of the present disclosure. The operations of the method 900 may be implemented by a network entity or its components as described herein. For example, the operations of the method 900 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 905, the method may include establishing a signaling connection with an access node, where the access node has an RRC connection with a second CU, and where the signaling connection is used for backhauling of communications for UEs that are served by the access node. The operations of block 905 may be performed in accordance with examples as disclosed herein. In some examples, aspects of the operations of 905 may be performed by a wireless connection establishment component 725 as described with reference to FIG. 7.

At 910, the method may include transmitting, to the access node, a first indication associated with suspension of the backhauling of the communications via the signaling connection. The operations of block 910 may be performed in accordance with examples as disclosed herein. In some examples, aspects of the operations of 910 may be performed by a release component 730 as described with reference to FIG. 7.

At 915, the method may include transmitting, to the second CU, a second indication that indicates the suspension of the backhauling of the communications via the signaling connection. The operations of block 915 may be performed in accordance with examples as disclosed herein. In some examples, aspects of the operations of 915 may be performed by a release component 730 as described with reference to FIG. 7.

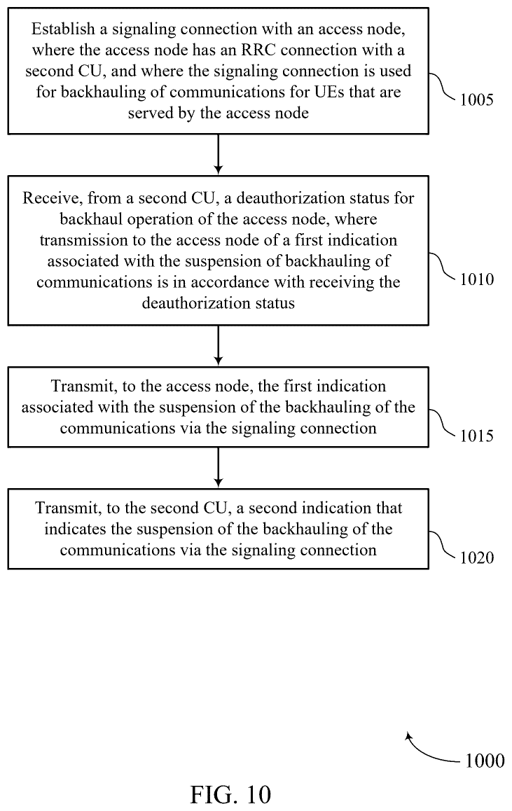

FIG. 10 shows a flowchart illustrating a method 1000 that supports techniques for backhaul release of an access node in accordance with aspects of the present disclosure. The operations of the method 1000 may be implemented by a network entity or its components as described herein. For example, the operations of the method 1000 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1005, the method may include establishing a signaling connection with an access node, where the access node has an RRC connection with a second CU, and where the signaling connection is used for backhauling of communications for UEs that are served by the access node. The operations of block 1005 may be performed in accordance with examples as disclosed herein. In some examples, aspects of the operations of 1005 may be performed by a wireless connection establishment component 725 as described with reference to FIG. 7.

At 1010, the method may include receiving, from the second CU, a deauthorization status for backhaul operation of the access node, where transmission to the access node of the first indication associated with the suspension of the backhauling of the communications is in accordance with receiving the deauthorization status. The operations of block 1010 may be performed in accordance with examples as disclosed herein. In some examples, aspects of the operations of 1010 may be performed by a backhaul monitoring component 740 as described with reference to FIG. 7.

At 1015, the method may include transmitting, to the access node, a first indication associated with suspension of the backhauling of the communications via the signaling connection. The operations of block 1015 may be performed in accordance with examples as disclosed herein. In some examples, aspects of the operations of 1015 may be performed by a release component 730 as described with reference to FIG. 7.

At 1020, the method may include transmitting, to the second CU, a second indication that indicates the suspension of the backhauling of the communications via the signaling connection. The operations of block 1020 may be performed in accordance with examples as disclosed herein. In some examples, aspects of the operations of 1020 may be performed by a release component 730 as described with reference to FIG. 7.

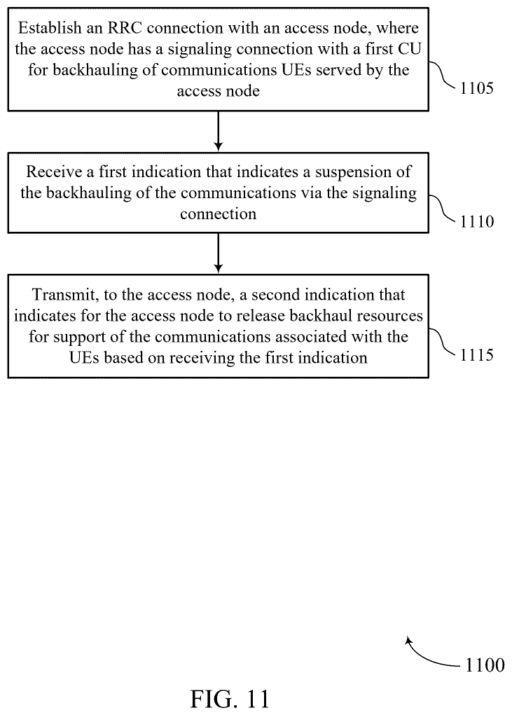

FIG. 11 shows a flowchart illustrating a method 1100 that supports techniques for backhaul release of an access node in accordance with aspects of the present disclosure. The operations of the method 1100 may be implemented by a network entity or its components as described herein. For example, the operations of the method 1100 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1105, the method may include establishing an RRC connection with an access node, where the access node has a signaling connection with a first CU for backhauling of communications with UEs served by the access node. The operations of block 1105 may be performed in accordance with examples as disclosed herein. In some examples, aspects of the operations of 1105 may be performed by a wireless connection establishment component 725 as described with reference to FIG. 7.

At 1110, the method may include receiving a first indication that indicates a suspension of the backhauling of the communications via the signaling connection. The operations of block 1110 may be performed in accordance with examples as disclosed herein. In some examples, aspects of the operations of 1110 may be performed by a release component 730 as described with reference to FIG. 7.

At 1115, the method may include transmitting, to the access node, a second indication that indicates for the access node to release backhaul resources for support of the communications associated with the UEs based on receiving the first indication. The operations of block 1115 may be performed in accordance with examples as disclosed herein. In some examples, aspects of the operations of 1115 may be performed by a release component 730 as described with reference to FIG. 7.

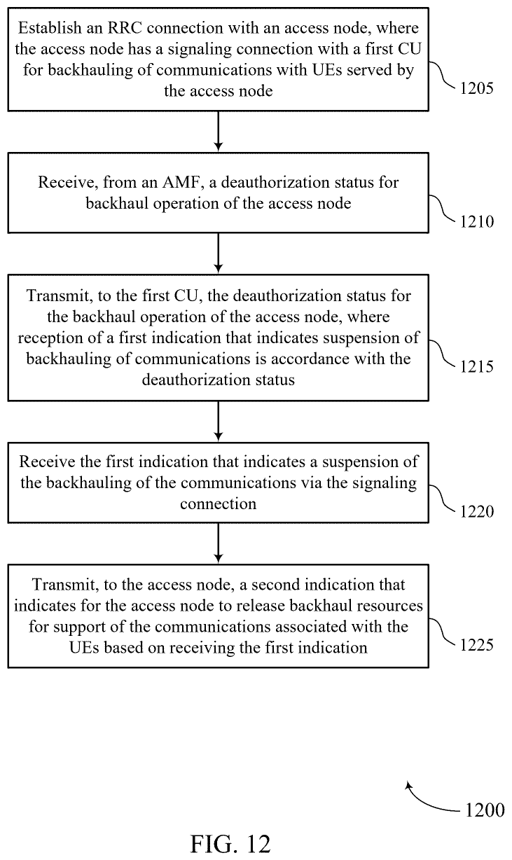

FIG. 12 shows a flowchart illustrating a method 1200 that supports techniques for backhaul release of an access node in accordance with aspects of the present disclosure. The operations of the method 1200 may be implemented by a network entity or its components as described herein. For example, the operations of the method 1200 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1205, the method may include establishing an RRC connection with an access node, where the access node has a signaling connection with a first CU for backhauling of communications with UEs served by the access node. The operations of block 1205 may be performed in accordance with examples as disclosed herein. In some examples, aspects of the operations of 1205 may be performed by a wireless connection establishment component 725 as described with reference to FIG. 7.

At 1210, the method may include receiving, from an AMF, a deauthorization status for backhaul operation of the access node. The operations of block 1210 may be performed in accordance with examples as disclosed herein. In some examples, aspects of the operations of 1210 may be performed by a backhaul monitoring component 745 as described with reference to FIG. 7.

At 1215, the method may include transmitting, to the first CU, the deauthorization status for the backhaul operation of the access node, where reception of the first indication that indicates the suspension of the backhauling of the communications is accordance with the deauthorization status. The operations of block 1215 may be performed in accordance with examples as disclosed herein. In some examples, aspects of the operations of 1215 may be performed by a release component 730 as described with reference to FIG. 7.

At 1220, the method may include receiving a first indication that indicates a suspension of the backhauling of the communications via the signaling connection. The operations of block 1220 may be performed in accordance with examples as disclosed herein. In some examples, aspects of the operations of 1220 may be performed by a release component 730 as described with reference to FIG. 7.

At 1225, the method may include transmitting, to the access node, a second indication that indicates for the access node to release backhaul resources for support of the communications associated with the UEs based on receiving the first indication. The operations of block 1225 may be performed in accordance with examples as disclosed herein. In some examples, aspects of the operations of 1225 may be performed by a release component 730 as described with reference to FIG. 7.

The following provides an overview of aspects of the present disclosure:

Aspect 1: A method for wireless communications, at a first CU, comprising: establishing a signaling connection with an access node, wherein the access node has an RRC connection with a second CU, and wherein the signaling connection is used for backhauling of communications for UEs that are served by the access node; transmitting, to the access node, a first indication associated with suspension of the backhauling of the communications via the signaling connection; and transmitting, to the second CU, a second indication that indicates the suspension of the backhauling of the communications via the signaling connection.

Aspect 2: The method of aspect 1, wherein the second indication that indicates the suspension of the backhauling of the communications indicates release of an F1 connection between the first CU and a DU of the access node.

Aspect 3: The method of any of aspects 1 through 2, wherein the second indication that indicates the suspension of the backhauling of the communications indicates that an F1 connection between the first CU and a DU of the access node is maintained during the suspension of the backhauling.

Aspect 4: The method of any of aspects 1 through 3, wherein transmitting the second indication further comprises: transmitting, to the second CU, an integrated access and backhaul transport migration modification request message that comprises the second indication.

Aspect 5: The method of any of aspects 1 through 4, wherein the second indication that indicates the suspension of the backhauling of the communications indicates that backhauling via the access node is suspended.

Aspect 6: The method of any of aspects 1 through 5, wherein the first indication indicates a request to release an F1 connection between the first CU and a DU of the access node; and the second indication indicates that the first CU has requested to release the F1 connection.

Aspect 7: The method of any of aspects 1 through 6, wherein the second indication that indicates the suspension of the backhauling of the communications indicates that the access node is serving zero UEs.

Aspect 8: The method of any of aspects 1 through 7, further comprising: receiving, from the second CU, a deauthorization status for backhaul operation of the access node, wherein transmission to the access node of the first indication associated with the suspension of the backhauling of the communications is in accordance with receiving the deauthorization status.

Aspect 9: The method of any of aspects 1 through 8, wherein the second indication further indicates for the second CU to release all data traffic associated with the first CU.

Aspect 10: A method for wireless communications, at a second CU, comprising: establishing an RRC connection with an access node, wherein the access node has a signaling connection with a first CU for backhauling of communications with UEs served by the access node; receiving a first indication that indicates a suspension of the backhauling of the communications via the signaling connection; and transmitting, to the access node, a second indication that indicates for the access node to release backhaul resources for support of the communications associated with the UEs based at least in part on receiving the first indication.

Aspect 11: The method of aspect 10, wherein the first indication that indicates the suspension of the backhauling of the communications indicates release of an F1 connection between the first CU and a DU of the access node.

Aspect 12: The method of any of aspects 10 through 11, wherein the first indication that indicates the suspension of the backhauling of the communications indicates that an F1 connection between the first CU and a DU of the access node is maintained during the suspension of the backhauling.

Aspect 13: The method of any of aspects 10 through 12, wherein receiving the first indication further comprises: receiving, from the first CU, an integrated access and backhaul transport migration modification request message that comprises the first indication.

Aspect 14: The method of any of aspects 10 through 13, wherein the first indication that indicates the suspension of the backhauling of the communications indicates that backhauling via the access node is suspended.

Aspect 15: The method of any of aspects 10 through 14, wherein the first indication indicates that the first CU has requested to release an F1 connection between the first CU and a DU of the access node.

Aspect 16: The method of any of aspects 10 through 15, wherein the first indication that indicates the suspension of the backhauling of the communications indicates that the access node is serving zero UEs.

Aspect 17: The method of any of aspects 10 through 16, further comprising: receiving, from an AMF, a deauthorization status for backhaul operation of the access node; and transmitting, to the first CU, the deauthorization status for the backhaul operation of the access node, wherein reception of the first indication that indicates the suspension of the backhauling of the communications is accordance with the deauthorization status.

Aspect 18: The method of any of aspects 10 through 17, wherein the first indication further indicates for the second CU to release all data traffic associated with the first CU.

Aspect 19: The method of any of aspects 10 through 18, wherein the second CU receives the first indication from the access node or from the first CU.

Aspect 20: The method of any of aspects 10 through 19, wherein the backhaul resources comprise a BAP address, a TNL address, a BAP reconfiguration, or a combination thereof.

Aspect 21: A first CU for wireless communications, comprising one or more memories storing processor-executable code, and one or more processors coupled with the one or more memories and individually or collectively operable to execute the code to cause the first CU to perform a method of any of aspects 1 through 9.

Aspect 22: A first CU for wireless communications, comprising at least one means for performing a method of any of aspects 1 through 9.

Aspect 23: A non-transitory computer-readable medium storing code for wireless communications, the code comprising instructions executable by a processor to perform a method of any of aspects 1 through 9.

Aspect 24: A second CU for wireless communications, comprising one or more memories storing processor-executable code, and one or more processors coupled with the one or more memories and individually or collectively operable to execute the code to cause the second CU to perform a method of any of aspects 10 through 20.

Aspect 25: A second CU for wireless communications, comprising at least one means for performing a method of any of aspects 10 through 20.

Aspect 26: A non-transitory computer-readable medium storing code for wireless communications, the code comprising instructions executable by a processor to perform a method of any of aspects 10 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first central unit (CU), comprising:
one or more memories storing processor-executable code; and
one or more processors coupled with the one or more memories and individually or collectively operable to execute the code to cause the first CU to:
establish a signaling connection with an access node, wherein the access node has a radio resource control (RRC) connection with a second CU, and wherein the signaling connection is used for backhauling of communications for user equipments (UEs) that are served by the access node;
transmit, to the access node, a first indication associated with suspension of the backhauling of the communications via the signaling connection; and
transmit, to the second CU, a second indication that indicates the suspension of the backhauling of the communications via the signaling connection.

2. The first CU of claim 1, wherein the second indication that indicates the suspension of the backhauling of the communications indicates release of an F1 connection between the first CU and a distributed unit (DU) of the access node.

3. The first CU of claim 1, wherein the second indication that indicates the suspension of the backhauling of the communications indicates that an F1 connection between the first CU and a distributed unit (DU) of the access node is maintained during the suspension of the backhauling.

4. The first CU of claim 1, wherein, to transmit the second indication, the one or more processors are individually or collectively further operable to execute the code to cause the first CU to:
transmit, to the second CU, an integrated access and backhaul transport migration modification request message that comprises the second indication.

5. The first CU of claim 1, wherein the second indication that indicates the suspension of the backhauling of the communications indicates that backhauling via the access node is suspended.

6. The first CU of claim 1, wherein:
the first indication indicates a request to release an F1 connection between the first CU and a distributed unit (DU) of the access node; and
the second indication indicates that the first CU has requested to release the F1 connection.

7. The first CU of claim 1, wherein the second indication that indicates the suspension of the backhauling of the communications indicates that the access node is serving zero user equipments (UEs).

8. The first CU of claim 1, wherein the one or more processors are individually or collectively further operable to execute the code to cause the first CU to:
receive, from the second CU, a deauthorization status for backhaul operation of the access node, wherein transmission to the access node of the first indication associated with the suspension of the backhauling of the communications is in accordance with receiving the deauthorization status.

9. The first CU of claim 1, wherein the second indication further indicates for the second CU to release all data traffic associated with the first CU.

10. A second central unit (CU), comprising:
one or more memories storing processor-executable code; and
one or more processors coupled with the one or more memories and individually or collectively operable to execute the code to cause the second CU to:
establish a radio resource control (RRC) connection with an access node, wherein the access node has a signaling connection with a first CU for backhauling of communications with user equipments (UEs) served by the access node;
receive a first indication that indicates a suspension of the backhauling of the communications via the signaling connection; and
transmit, to the access node, a second indication that indicates for the access node to release backhaul resources for support of the communications associated with the UEs based at least in part on receiving the first indication.

11. The second CU of claim 10, wherein the first indication that indicates the suspension of the backhauling of the communications indicates release of an F1 connection between the first CU and a distributed unit (DU) of the access node.

12. The second CU of claim 10, wherein the first indication that indicates the suspension of the backhauling of the communications indicates that an F1 connection between the first CU and a distributed unit (DU) of the access node is maintained during the suspension of the backhauling.

13. The second CU of claim 10, wherein, to receive the first indication, the one or more processors are individually or collectively further operable to execute the code to cause the second CU to:
receive, from the first CU, an integrated access and backhaul transport migration modification request message that comprises the first indication.

14. The second CU of claim 10, wherein the first indication that indicates the suspension of the backhauling of the communications indicates that backhauling via the access node is suspended.

15. The second CU of claim 10, wherein the first indication indicates that the first CU has requested to release an F1 connection between the first CU and a distributed unit (DU) of the access node.

16. The second CU of claim 10, wherein the first indication that indicates the suspension of the backhauling of the communications indicates that the access node is serving zero user equipments (UEs).

17. The second CU of claim 10, wherein the one or more processors are individually or collectively further operable to execute the code to cause the second CU to:
receive, from an authorization and mobility management function (AMF), a deauthorization status for backhaul operation of the access node; and
transmit, to the first CU, the deauthorization status for the backhaul operation of the access node, wherein reception of the first indication that indicates the suspension of the backhauling of the communications is accordance with the deauthorization status.

18. The second CU of claim 10, wherein the first indication further indicates for the second CU to release all data traffic associated with the first CU.

19. The second CU of claim 10, wherein the second CU receives the first indication from the access node or from the first CU.

20. The second CU of claim 10, wherein the backhaul resources comprise a backhaul adaptation protocol address, a transport network layer address, a backhaul adaptation protocol reconfiguration, or a combination thereof.

21. A method for wireless communications, at a first central unit (CU), comprising:
establishing a signaling connection with an access node, wherein the access node has a radio resource control (RRC) connection with a second CU, and wherein the signaling connection is used for backhauling of communications for user equipments (UEs) that are served by the access node;
transmitting, to the access node, a first indication associated with suspension of the backhauling of the communications via the signaling connection; and
transmitting, to the second CU, a second indication that indicates the suspension of the backhauling of the communications via the signaling connection.

22. The method of claim 21, wherein the second indication that indicates the suspension of the backhauling of the communications indicates release of an F1 connection between the first CU and a distributed unit (DU) of the access node.

23. The method of claim 21, wherein the second indication that indicates the suspension of the backhauling of the communications indicates that an F1 connection between the first CU and a distributed unit (DU) of the access node is maintained during the suspension of the backhauling.

24. The method of claim 21, wherein transmitting the second indication further comprises:
transmitting, to the second CU, an integrated access and backhaul transport migration modification request message that comprises the second indication.

25. The method of claim 21, wherein the second indication that indicates the suspension of the backhauling of the communications indicates that backhauling via the access node is suspended.

26. A method for wireless communications, at a second central unit (CU), comprising:
establishing a radio resource control (RRC) connection with an access node, wherein the access node has a signaling connection with a first CU for backhauling of communications with user equipments (UEs) served by the access node;
receiving a first indication that indicates a suspension of the backhauling of the communications via the signaling connection; and
transmitting, to the access node, a second indication that indicates for the access node to release backhaul resources for support of the communications associated with the UEs based at least in part on receiving the first indication.

27. The method of claim 26, wherein the first indication that indicates the suspension of the backhauling of the communications indicates release of an F1 connection between the first CU and a distributed unit (DU) of the access node.

28. The method of claim 26, wherein the first indication that indicates the suspension of the backhauling of the communications indicates that an F1 connection between the first CU and a distributed unit (DU) of the access node is maintained during the suspension of the backhauling.

29. The method of claim 26, wherein receiving the first indication further comprises:
receiving, from the first CU, an integrated access and backhaul transport migration modification request message that comprises the first indication.

30. The method of claim 26, wherein the first indication that indicates the suspension of the backhauling of the communications indicates that backhauling via the access node is suspended.
